(19) United States
(12) Patent Application Publication
(10) Pub. No.: US 2025/0305875 A1
(43) Pub. Date: Oct. 2, 2025

(54) VIRTUAL INSTRUMENT SYSTEM AND METHOD FOR SPECTROSCOPIC DATA ACQUISITION AND PROCESSING

(71) Applicant: UNIVERSITY OF PUERTO RICO, San Juan, PR (US)

(72) Inventors: Samuel P. Hernández-Rivera, Mayagüez, PR (US); Vladimir Villanueva-López, Utuado, PR (US); Leonardo C. Pacheco-Londoño, San Juan, PR (US)

(73) Assignee: UNIVERSITY OF PUERTO RICO, San Juan, PR (US)

(21) Appl. No.: 18/864,336

(22) PCT Filed: May 9, 2023
(86) PCT No.: PCT/US2023/021547

§ 371 Date: Nov. 8, 2024

Related U.S. Application Data
(60) Provisional application No. 63/340,270, filed on May 10, 2022.

(51) Int. Cl. G01J 3/28; G01N 21/35

(52) U.S. Cl. CPC G01J 3/28; G01N 21/35; G01J 2003/283; G01N 2201/06113

(57) ABSTRACT

Systems and methods for interfacing a laser system with a detector can include a computer system receiving reference data points representing samples of a first signal generated by the detector responsive to a first light signal emitted by the laser system, and receiving sample data points representing samples of a second signal generated by the detector responsive to a second light signal emitted by the laser system. The first light signal interact with a reference medium before reaching the detector and the second light signal interacts with a sample medium before reaching the detector. The computer system can generate a ratio signal using the reference data points and the sample data points, apply wavelet-based filtering to the ratio signal, and cause the filtered ratio signal to be displayed on a display device.

### CROSS REFERENCE TO RELATED APPLICATIONS

This application claims the benefit of, and priority to, the U.S. Provisional Application No. 63/340,270 filed on May 10, 2022, and entitled “VIRTUAL INSTRUMENT SYSTEM AND METHOD FOR SPECTROSCOPIC DATA ACQUISITION AND PROCESSING” which is incorporated herein by reference in its entirety.

### GOVERNMENT RIGHTS

This invention was made with government support under W911NF-11-1-0152 awarded by U.S. Department of Defense, under DODRIF11-DTRA020-P-0017 awarded by the Defense Threat Reduction Agency (DTRA), DOD, and under 2013-ST-061-ED0001 awarded by the US Department of Homeland Security. The government has certain rights in the invention.

### FIELD OF THE DISCLOSURE

The present application relates generally to systems and methods for interfacing a laser with a detector in a laser spectroscopy setting. Specifically, systems and methods described herein enable fast and efficient laser spectroscopic data acquisition and on-the-fly analysis and display of the spectroscopic data.

### BACKGROUND

Mid-infrared (MIR) lasers are high-brightness energy sources that are replacing conventional thermal sources (globars) in many infrared spectroscopy (IRS) techniques. Although not all laser properties have been exploited to the maximum of their potential, properties such as collimation, polarization, high brightness, and very high resolution have contributed to the recasting of IRS techniques. One of these devices, a quantum cascade laser (QCL), is a solid-state, unipolar, semiconductor-based, powerful radiation source. As a source of MIR radiation, it can be used to excite the vibrational signatures of the molecules present in samples, allowing their identification by using advanced chemometrics analysis. The far superior sensitivities that can be achieved using QCLs compared with thermal Fourier-transform infrared spectroscopy (FTIR) sources have been demonstrated, showing that these instruments are powerful tools for spectroscopic measurements. Commercial MIR lasers (QCLs) are pre-dispersive systems where the grating-selected wavelength of the output beam can be scanned very quickly, and they maintain high accuracy and precision. This fact has allowed their use in multiple applications, including standoff detection, monitoring chemical reactions, detecting explosives, analyzing pharmaceutical formulations, biomedical applications, and analyzing biological samples.

Some applications in bio-analytics combine QCL with waveguides. Notably, the combination of Attenuated Total Reflectance (ATR) with Surface-Enhanced Infrared Absorption (SEIRA) with a powerful source, such as QCL, has led to the development of miniaturized, highly sensitive chemical biosensors with low detection limits of molecules in complex matrices. Furthermore, the capabilities of QCL not only allow MIR measurements at a small scale but also reach an impressive limit of detection (˜1 μgm⁻³) of gases in a long open path (428 m). The versatility of QCL extends beyond chemical detection to applications in communications.

### SUMMARY

According to at least one aspect of the current disclosure, a system can include one or more processors and a memory storing executable instructions. The executable instructions, when executed by the one or more processors, causes the one or more processors to receive reference data points representing samples of a first signal generated by a detector responsive to a first light signal emitted by a laser system, and receive sample data points representing samples of a second signal generated by the detector responsive to a second light signal emitted by the laser system. The first light signal interacts with a reference medium before reaching the detector and the second light signal interacting with a sample medium before reaching the detector. The one or more processors can generate a ratio signal using the reference data points and the sample data points and cause the filtered ratio signal to be displayed on a display device.

In some implementations, the laser system includes a quantum cascade laser (QCL). In some implementations, the detector includes a mercury-cadmium-telluride detector.

In some implementations, the one or more processors can provide a user interface (UI) and receive a signal via a user interface (UI) to trigger at least one of reception of the reference data points, reception of the sample data points, or processing of the reference data points and the sample data points. The UI can include tabs or icon corresponding to different states of a state machine for executing reception and processing of signals emitted by the laser system. The state machine can include an initialization state for setting parameters for controlling the reception and processing of signals emitted by the laser system. The state machine can include a wait state during which the one or more processors is configured to wait for input instructions via the UI. The state machine can include a state for reception of reference data points. The state machine can include a state for reception of sample data points. The state machine can include a state for processing of the reference data points and the sample data points.

According to at least one aspect of the current disclosure, a method can include receiving, by a computer system including one or more processors, reference data points representing samples of a first signal generated by a detector responsive to a first light signal emitted by a laser system. The first light signal interacts with a reference medium before reaching the detector. The method can include receiving, by the computer system, sample data points representing samples of a second signal generated by the detector responsive to a second light signal emitted by the laser system. The second light signal interacts with a sample medium before reaching the detector. The method can include the computer system generating a ratio signal using the reference data points and the sample data points, applying wavelet-based filtering to the ratio signal, and causing the filtered ratio signal to be displayed on a display device.

In some implementations, the laser system includes a quantum cascade laser (QCL). In some implementations, the detector includes a mercury-cadmium-telluride detector.

In some implementations, the method includes providing a user interface (UI) and receiving a signal via a user interface (UI) to trigger at least one of reception of the reference data points, reception of the sample data points, or processing of the reference data points and the sample data points. The UI can include tabs or icon corresponding to different states of a state machine for executing reception and processing of signals emitted by the laser system. The state machine can include an initialization state for setting parameters for controlling the reception and processing of signals emitted by the laser system. The state machine can include a wait state during which the one or more processors is configured to wait for input instructions via the UI. The state machine can include a state for reception of reference data points. The state machine can include a state for reception of sample data points. The state machine can include a state for processing of the reference data points and the sample data.

According to at least one aspect of the current disclosure, a non-transitory computer-readable medium storing computer instructions. The computer instructions when executed by one or more processors cause the one or more processors to receive reference data points representing samples of a first signal generated by a detector responsive to a first light signal emitted by a laser system. The first light signal interacts with a reference medium before reaching the detector. The one or more processors can receive sample data points representing samples of a second signal generated by the detector responsive to a second light signal emitted by the laser system. The second light signal interacts with a sample medium before reaching the detector. The one or more processors can generate a ratio signal using the reference data points and the sample data points, apply wavelet-based filtering to the ratio signal, and cause the filtered ratio signal to be displayed on a display device.

### BRIEF DESCRIPTION OF THE DRAWINGS

FIG. 1 is a schematic diagram of an experimental setup for MIR laser absorption spectroscopy, according to example embodiments.

FIG. 2 shows a state machine design pattern of the VI-based interface and data processing system, according to example embodiments.

FIG. 3 shows a front-panel or UI of the VI-based interface and data processing system, according to example embodiments.

FIG. 4 shows a flowchart illustrating a method of interfacing a laser system with a detector and processing signals generated by the detector, according to example embodiments.

FIGS. 5A-5G show block diagrams of various machine states and Sub-VIs, according to example embodiments.

FIG. 6 shows plots illustrating a portion of the signal pulses' waveform from the detector for open path lasing and after placing the calibration polystyrene film, according to example embodiments.

FIG. 7 shows a normalized signal of ten averaged waveforms before and after placing a polystyrene film in front of the detector, according to example embodiments.

FIG. 8 shows (a) transmittance spectrum of polystyrene film from experiments, IR spectrum for water vapor from NIST, and FTIR spectrum of polystyrene film from Lancashire and Davies, and (b) polystyrene spectra acquired with the experimental setup at 0.05 cm⁻¹ step size and data reduction to obtain spectra with a step size of 0.5 cm⁻¹ and 1.00 cm⁻¹, according to example embodiments.

FIG. 9 shows plots illustrating comparisons between various types of filters, according to example embodiments.

FIG. 10 shows schematic diagrams of experimental setups for (a) Diffuse Reflectance Infrared Spectroscopy (DRIRS), (b) Reflection-Absorption Infrared Spectroscopy (RAIRS), and (c) Attenuated Total Reflectance (ATR), according to example embodiments.

FIG. 11 shows the RAIRS spectra of PETN/SS at several concentrations, wherein according to an example, the vibrational signatures of PETN in this spectral region match the PETN vibrational signatures reported in the literature and standard PETN spectra from NIST.

FIG. 12 shows the spectra of caffeine, acetaminophen, and benzoic acid, according to example embodiments.

FIG. 13 shows QCL-ATR spectra at different applied pressure levels of (a) acetonitrile and (b) caffeine crystals, according to example embodiments.

### DETAILED DESCRIPTION

Experiments employing pulsed lasers call for customizable software to synchronize detectors to acquire the desired measurements. Applications involving such experiments include monitoring a chemical process to detect changes in intensities. The intensities can be correlated to changes in the concentration of target species and measuring the target species concentration as a function of temperature. Measuring steady-state intensities in absorption, emission, or reflectance experiments calls for interfacing systems or software to interface a detector with a laser and handle communication and synchronization to acquire data. One can use high-level programming languages such as MATLAB™ Visual Basic™ or Python™ in developing the interfacing software. However, since these programming languages are text-based, users must know how to program to design or modify an interface that controls the instrument for data acquisition and post-acquisition signal processing. Also, it would be difficult to modify or customize the interface to accommodate a different experimental setting.

Interfacing a nanosecond pulsed laser system to a fast detection system is not a trivial or easy problem to solve. Traditional spectroscopic instruments rely on electric measurements, not on software, such as using a boxcar average or integrator, an electronic instrument that removes noise and enhances signal. However, the operating range of the boxcar average or integrator is limited by its electronic circuit. Also, to the best knowledge of the inventors, no data acquisition and analysis routines to interface a laser with a detector are publicly available. The development of an interface dedicated to acquiring spectroscopic data from a pulsed laser source and a detector using a spectroscopic software suite has not been thoroughly discussed in the literature. Some research has focused on the algorithms that can be employed for post-acquisition analysis. However, no published research fully describes an interfacing procedure that could be programmed to couple and synchronize a detector to a laser. Commercial solutions are usually kept secret and are designed and built for a specific experimental setting but are not customizable for other experimental settings. Specifically, a commercial solution is usually designed for specific laser and detector models.

Virtual Instruments (VIs), e.g., Virtual Instrument file formats, are used by National Instruments (now NI, Austin, TX, USA) in its Lab VIEW™ development software. Lab VIEW™ is a software-based graphical programming language widely used for data acquisition, signal processing, and instrument control. Lab VIEW™ allows users to develop applications for automating and controlling processes in science, engineering, and other environments. NI uses the concept of “virtual instrumentation” to generalize and accelerate the development of such applications. VI-based computer calculations have become popular due to their flexibility in performing multiple tasks, such as control measurement instrumentation, automating processes, communicating data across networks, and analyzing data. A virtual instrument (VI) system comprises customizable software that uses a graphical interface and measurement hardware created by the user. The development of a VI dedicated to acquiring spectroscopic data from a pulsed laser source and a detector using a spectroscopic software suite has not been thoroughly discussed in the literature.

In the current disclosure, Lab VIEW™ is selected to develop a VI-based solution to solve the problem of interfacing the detector with the laser for data acquisition and post-acquisition data processing. It is to be noted that other graphical programming languages can be used in some implementations. In some implementations, the hardware can include a nanosecond pulsed laser, a fast data acquisition board, an analog to digital conversion card, and an infrared detector. The instructions for the VI-based solution can be submitted in block diagram form using modules (sub-VIs) in graphical icons. Each sub-VI can include one or more executable functions. Sub-VIs can be interconnected by lines that represent conduction wires used as data transfer channels. The VIs can be built from multiple sub-VIs and have a front panel and a block diagram. Several researchers have built in-house VIs based on Lab VIEW™ for spectroscopic measurements.

The VI-based solution described herein is implemented as a flexible and scalable Lab VIEW™ VI for MIR measurements in transmission mode using a QCL or any other pulsed laser source. The interface described herein can be customized for various types of lasers and/or detectors and/or can be adapted for various applications involving a sensor and signal processing of acquired data. According to example embodiments, the systems and methods described herein also improve post-acquisition processing to mitigate or eliminate ringing effects in acquired signals, e.g., due to water vapor.

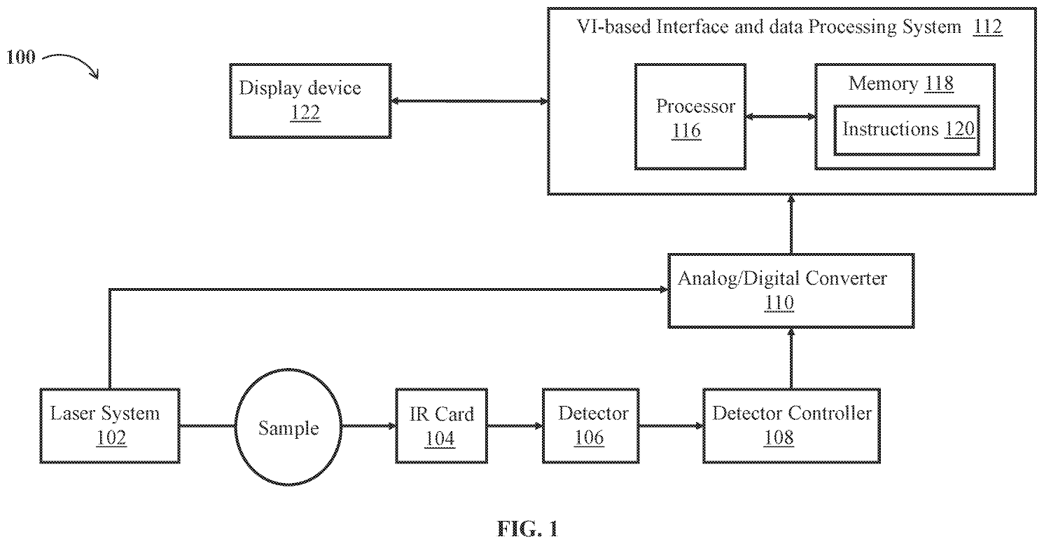

Referring now to FIG. 1, a schematic diagram of an experimental setup 100 for MIR laser absorption spectroscopy is shown, according to example embodiments. In brief overview, the experimental setup 100 can include a laser system 102, an infra-red (IR) card 104, a detector 106, a detector controller 108, an analog-to-digital converter 110, a VI-based interfacing and data processing system 112, and a display device 114. The VI-based interfacing and data processing system 112 can include processor 116 and memory 118. Memory 118 can include executable instructions 120 executed by processor 116 to perform processes associated with the VI-based interfacing and data processing system 112.

Laser system 102 can be a MIR laser system with a Mini-QCL™ IR source (Block Engineering, LLC, Southborough, MA, USA) that emits pulses from 930 to 1375 cm⁻¹ and can reach a peak power of up to 400 mW. In the experiments described herein, the Mini-QCL™ laser was used, and QCL transmission measurements of a calibration polystyrene film (IR card) were carried out according to the schematic diagram shown in FIG. 1. The laser system 102 can include a tunable external cavity (EC) laser with a broadband QCL chip, which is the engine inside the Mini-QCL™ IR Source. The EC-QCL has a Littrow configuration with back extraction, with a grating as the tuning element. The grating angle selects the diffracted light wavelength, which couples back into the QCL chip and creates a laser at a single wavelength.

The IR card (polystyrene film) 104 calibrates the wavenumber/wavelength scale in pre-dispersive MIR laser systems.

Light emitted by the laser system 102 interacts with the sample and is absorbed or reflected at particular wavelengths. The detector 106 can receive and measure the light signal emitted by the laser system 102. Specifically, detector 116 can generate an electric signal responsive to receiving the light emitted by the laser system 102. The signal intensity (in volts) of the signal generated by detector 106 is measured as a function of wavelength and is used to generate a spectrum. Using a QCL allows for narrowband emission, high brightness, collimated output beam, linearly polarized output, and insensitivity to stray light due to the laser's fast pulsing, enabling extremely sensitive standoff measurements. Detector 106 can include a mercury-cadmium-telluride (HgCdTe or MCT) detector such as model PVI-4TE-10.6 (VIGO Systems; Boston Electronics, Brookline, MA, USA), which can convert highly collimated MIR light pulses from the EC-QCL laser system into an electrical signal. For example, detector 106 can include a zinc selenide (ZnSe) window with an active area of 1 mm×1 mm. Other detector specifications include photovoltaic operation, optically immersed hyperhemispherical lens, TO-8 package window, AR-coated ZnSe, and wedged 3°.

Table 1 shows the optical, mechanical, and electrical specifications of the EC-QCL laser system used in the experiments described herein. The laser tuning can be controlled via three modes which are a “Move Tune” mode for manual control, a “Step Tune” mode allowing for a user-programmable sequence, and a “Sweep Tune” mode in which the user can program linear scanning sweeps. In some implementations, the Sweep Tune can be configured to operate in steps where the EC-QCL laser system produces light pulses of a step size of 0.05 cm⁻¹. The dwell time and operational range are also tunable. The EC-QCL laser system can operate at a repetition frequency of up to 3 MHz. In some implementations, the repetition rate can be 100 kHz, and the pulse width can be 500 ns. For example, these values can be selected to suit the characteristics of a detector controller 108 (e.g., the embedded NI controller PXIe-8115) and the analog-to-digital converter 110 (e.g., the high-speed NI digitizer PXI-5124).

TABLE 1
EC-QC laser specifications
BE Mini-QCL ™ Specifications

| Gap-Free Tuning Range | λ ≈ 7.3-10.7 μm (Δν ~440 cm⁻¹) | |
|---|---|---|
| Spectral Linewidth | <1 | cm⁻¹ |
| Spectral Accuracy/ | <2 cm⁻¹/<0.6 cm⁻¹ | |
| Repeatability | | |
| Maximum Peak Power | 400 | mW |
| Average Power | 0.5-20 mW (5% duty-cycle) | |
| Power Stability | <5% pulse-to-pulse | |
| | <0.05% over 10 ms @ 1 MHz | |
| Pulse Width | 20-300 | ns |
| Pulse Repetition | Up to 3 MHz | |
| Maximum Duty Cycle | 2.5-15% | |
| Beam Quality | Single spatial mode | |
| Beam Diameter | 2 × 4 mm², collimated output | |
| Beam Divergence | <5 | mrad |
| Pointing Stability | <1 | mrad |

| | |
|---|---|
| Polarization | Vertically polarized, 100:1 extinction |
| Tuning Modes | Move Tune - manual control |
| | Step Tune - programmable sequences |
| Step Tune Speed | 10 cm⁻¹ step < 1 ms |
| | □ Example: Step across 1000 cm⁻¹ in 1.1 seconds with 100 |
| Sweep Tune Speed | Linear sweep >25 cm⁻¹/ms |
| Computer Control | Wireless; Ethernet; HTML/SOAP |
| | Analog/Digital monitoring of wavelength |
| Analog Pulse Control | Internal Trigger: Sync Out and adjustable offset |
| | External Trigger: laser pulse & wavelength tune |

The detector controller 108 can be integrated with the detector 106. The detector controller 108 can optimize the measurement signals (or signals generated responsive to light received from the laser system 102) by applying signal pre-amplification and/or noise filtering. The detector controller 108 can, for example, be a programmable controller (PTCC-01-BAS) from VIGO systems.

The analog-to-digital converter 110 can receive an analog electrical signal from detector 106 or the detector controller 108 and digitize the received analog signal to generate a corresponding digital signal. The analog-to-digital converter 110 can include a high-speed oscilloscope digitizer (PXI-5124) capable of operating at a maximum sampling rate of 200 mega samples per second (200 MHz). In some implementations, the laser system 102 can send a sync-out trigger pulse to the analog-to-digital converter 110 to trigger the acquisition of each pulse at each wavenumber. Specifically, the laser system 102 can produce an analog electric pulse trigger before each laser pulse to be emitted. The analog-to-digital converter 110 (e.g., PXI-5124) can capture the analog electric pulse trigger and, in response, initiate recording of the data, e.g., at a rising edge level of one volt. The analog-to-digital converter 110 can receive a waveform in the form of voltage as a function of time and pass it (in digital form) to the VI-based Interface and data processing system 112 for processing to obtain a laser-excited spectrum.

The laser system 102 can be controlled through an Ethernet interface. The laser system 102 can illuminate a polystyrene film (IR card), and the amount of light transmitted can be measured by detector 106 (e.g., a sensitive mercury-cadmium-telluride (HgCdTe or MCT) detector model PVI-4TE-10.6 by VIGO Systems; Boston Electronics, Brookline, MA, USA). The detector 106 can convert the highly collimated MIR light pulses from the EC-QCL laser system into an electrical signal. A compact four-stage system capable of thermoelectrically cooling the detector 106 can be used. The compact four-stage system can be selected based on its performance in the spectral range from 900 to 4000 cm⁻¹ (2.5-11 μm). For instance, this spectral range can select a compact four-stage system with a detectivity (D*) of at least 4.5×109 cm Hz 0.5 W at λopt (943.40 cm⁻¹).

The VI-based interface and data processing system 112 can include memory 118 storing executable instructions 120 and processor 116 that is communicatively coupled to the memory 118. Processor 116 can execute the instructions 120 to perform processes associated with the VI-based interface and data processing system 112. The executable instructions 120 can represent a software implementation of a VI system based on Lab VIEW™ 2012 developed for MIR laser spectroscopy experiments.

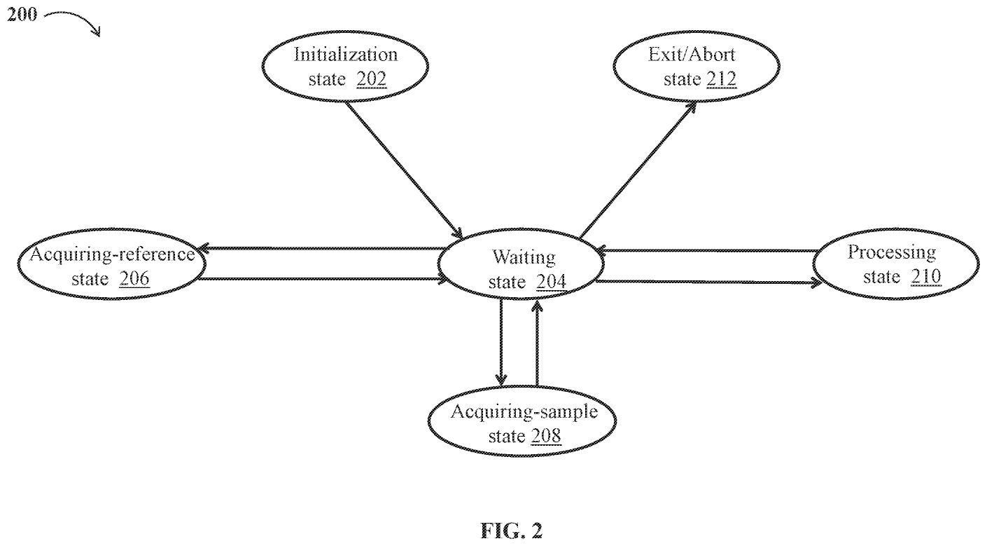

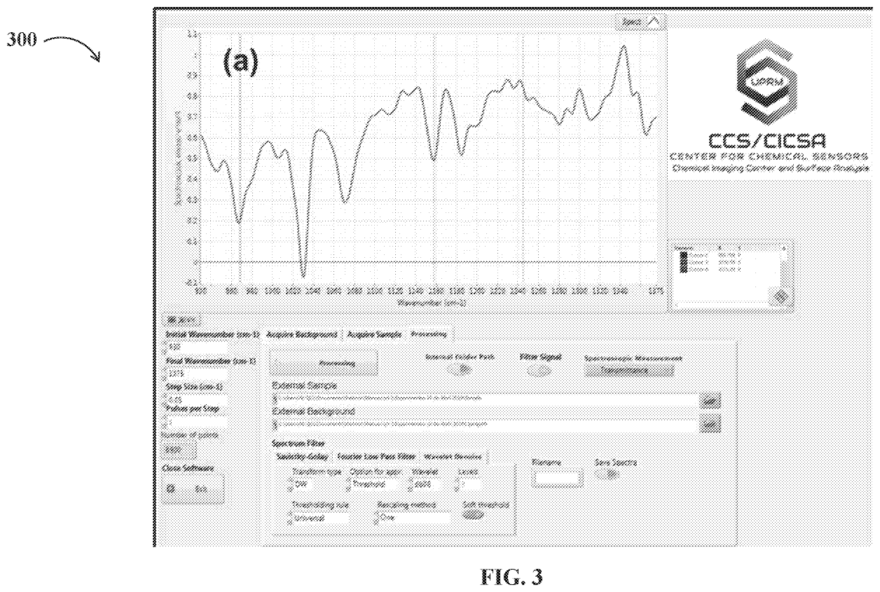

Referring to FIG. 2, the VI-based interface and data processing system 112 can have a state machine 200 design pattern. The state machine 200 can include a finite number of states executable by processor 116, for example, responsive to user interactions with user interface (UI) displayed on the display device 122. For example, the user can click a bottom or icon to trigger the data acquisition. The state machine 200 can include initializing state 202, wait for event state (or waiting state) 204, acquiring-reference state 206, acquiring-sample state 208, processing state 210, and exit/abort state 212. Each state can include several sub-VIs with specific corresponding functionalities. The user can control the transition from one state to another state through a front panel or UI by clicking buttons or icons related to the acquisition of reference/background signal, acquisition of signals of the sample of interest, and/or processing of the spectra. In some implementations, an internal instruction may cause an automatic return to the waiting state 204 to wait for user response or instructions before transitioning to another state.

Referring to FIG. 3, a front-panel or UI 300 is shown, according to example embodiments. The UI 300 can include an “Acquire Background” tab for triggering signal or data acquisition of a reference, an “Acquire Sample” tab for triggering signal or data acquisition of a sample, and a “Processing” tab for triggering post-acquisition processing. The UI can include input fields to specify data acquisition parameters, such as wavenumber range, a step size, the number of pulses transmitted per step, and/or the number of data points collected.

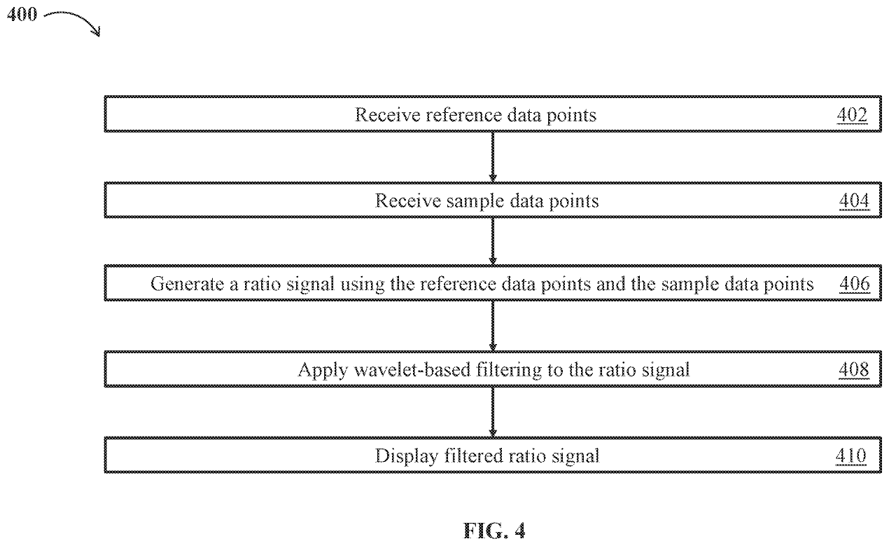

Referring now to FIG. 4, a flowchart illustrating a method 400 for interfacing a laser system with a detector and processing signals generated by the detector is shown, according to example embodiments. In brief overview, method 400 can include receiving reference data points (STEP 402) and receiving sample data points (STEP 404). The method 400 can include generating a ratio of the sample data points (spectral intensity of the sample in volts; Vs) to the reference data points (spectral intensity of the reference in volts, VR) (STEP 406). The method 400 can include applying wavelet-based filtering to the ratio signal (STEP 408) and providing the filtered ratio signal for display on a display device (STEP 410). The method 400 can be executed by the VI-based interfacing and data processing system 112 or one or more processors, such as processor 116. The steps of the method 400 are discussed in further detail below in relation to various states of the state machine 200 and the experimental results presented herein.

### Initialization State

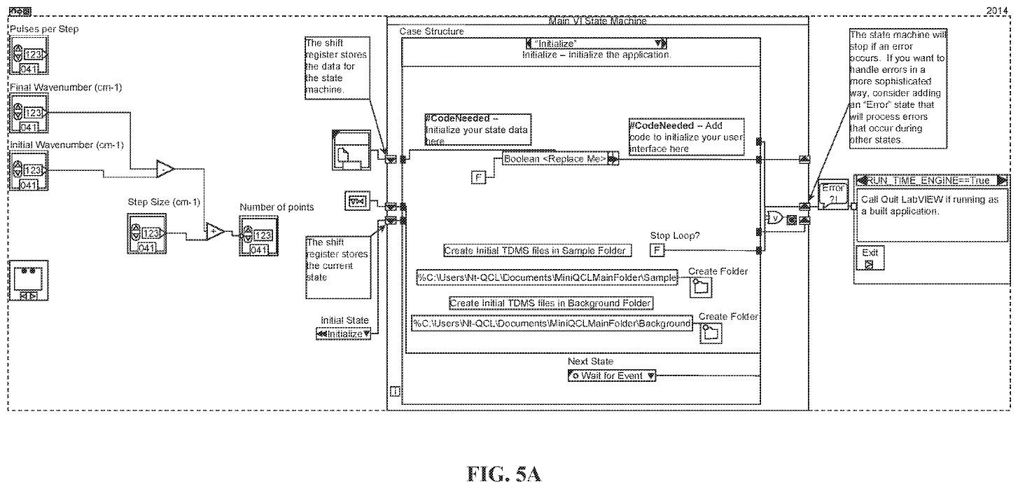

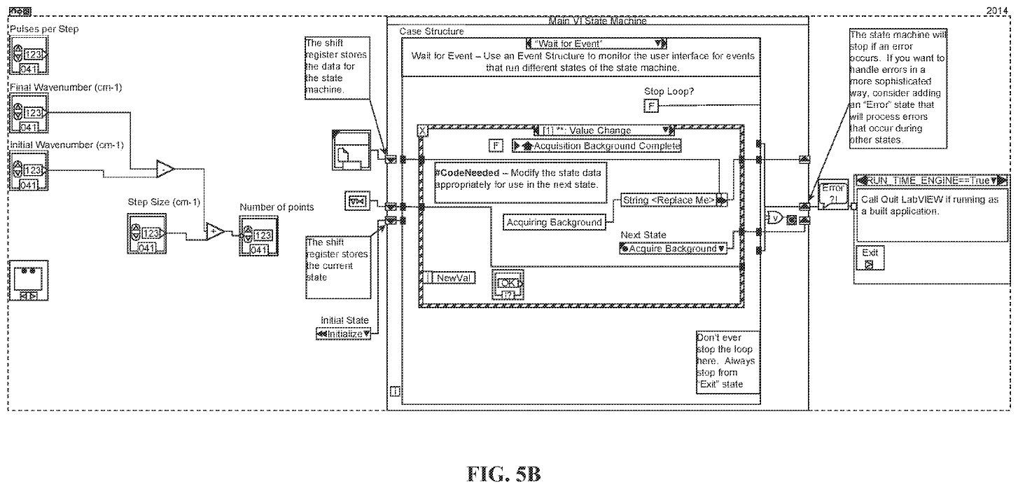

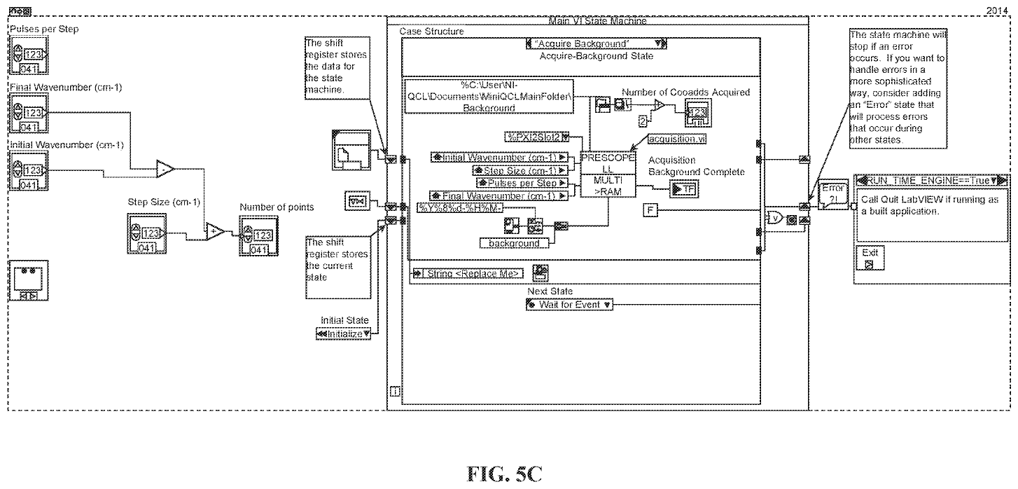

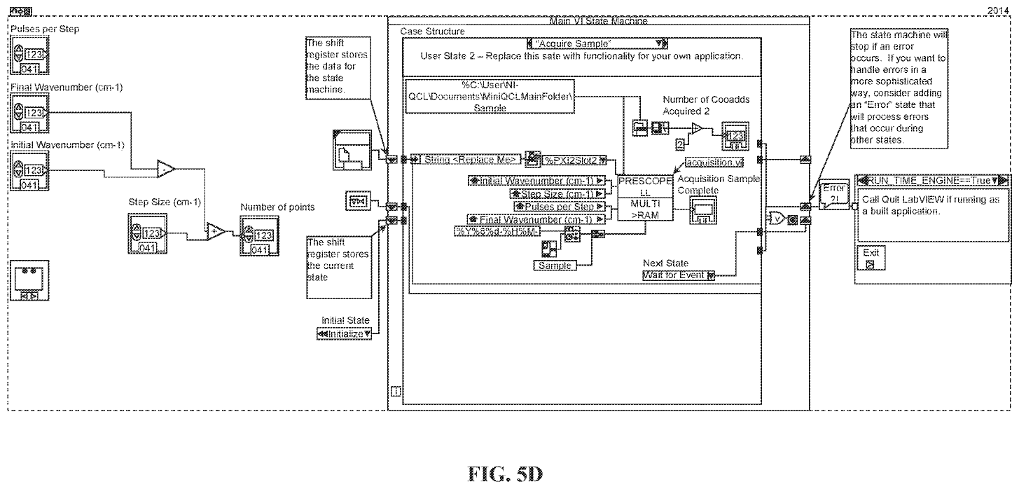

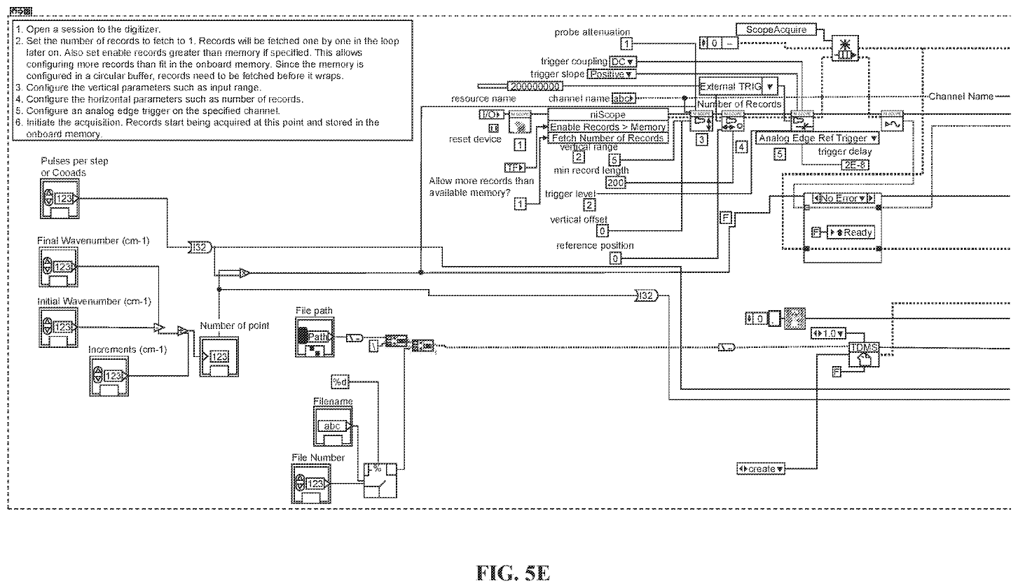

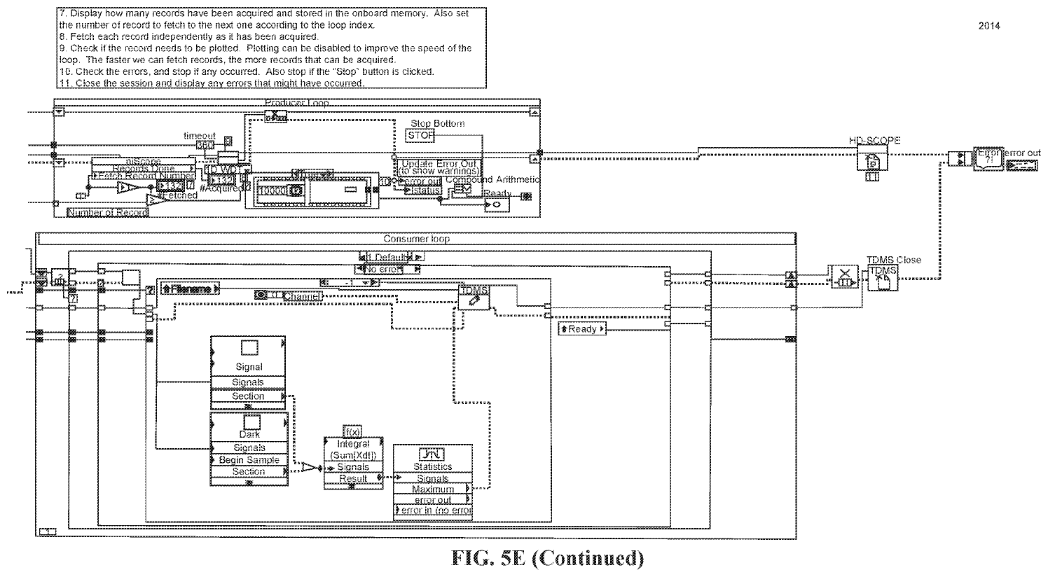

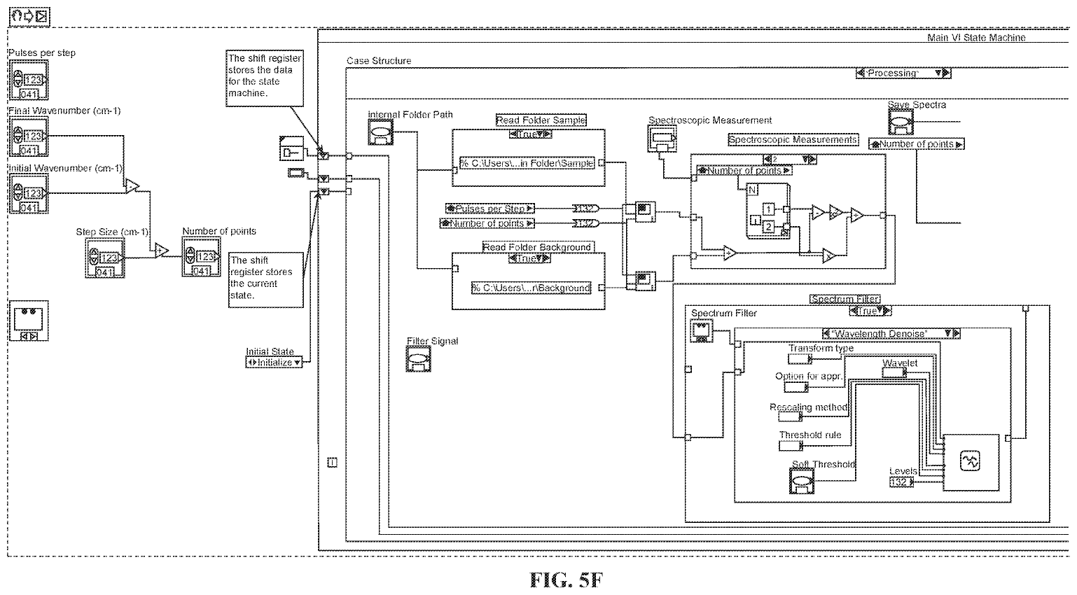

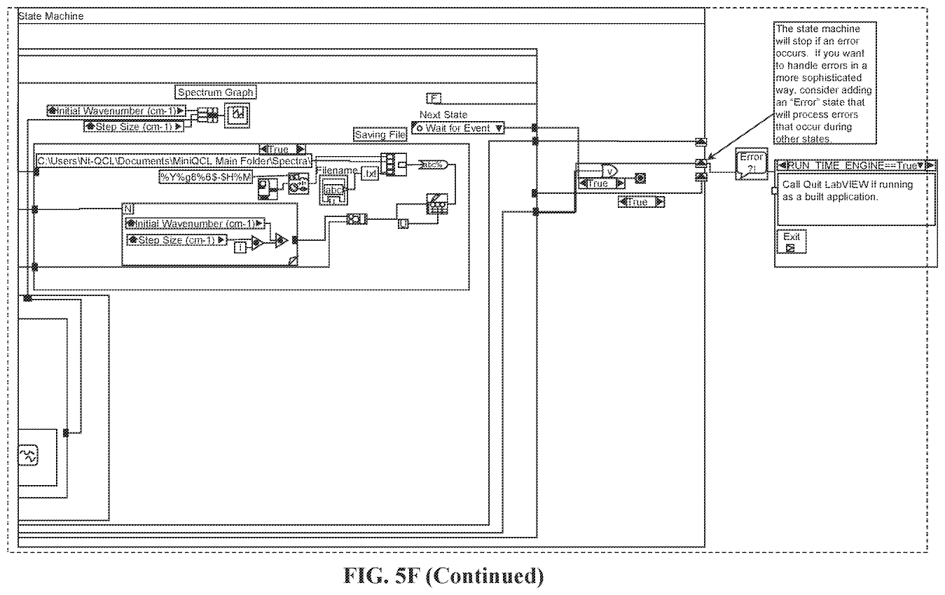

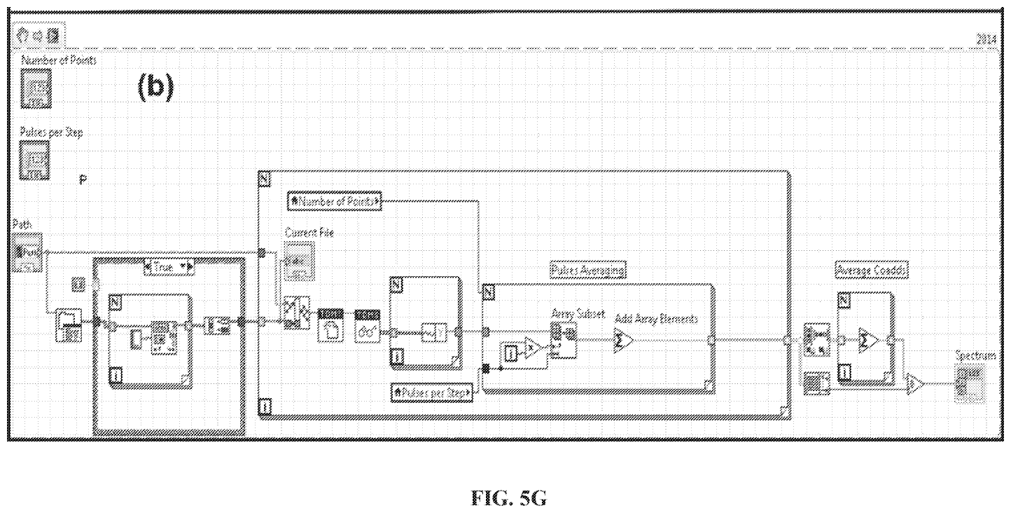

The initialization state 202 can be viewed as the default initial state. During the initialization state, the user can input various parameter values for parameters associated with different input fields of the UI 300. Processor 116 can acquire the parameter values via the front panel or UI 300. Processor 116 can control the data acquisition and/or post-acquisition processing using the parameter values received via the UI 300. The parameters can include an initial wavenumber, a final wavenumber, a step size, and the number of pulses per step. Processor 116 or VI-based interface and data processing system 112 may not control laser system 102 but can receive inputs entered by the user via UI 300, reflecting the needs and/or capabilities of various components of the experimental setup 100. Processor 116 can automatically create two temporary folders in this state, one for the sample trace and another for the background trace. In some implementations, these folders can include the NI Technical Data Management Streaming (TDMS) format files that store the signals. If there is an error, processor 116 will stop, otherwise transition to waiting state 204 to wait for a new event state based on user input or interaction with UI 300. Initialization state 202 can be viewed as the state to initiate the method 400. FIG. 5A shows a block diagram of initialization state 202, according to example embodiments.

### Waiting State

This state can also be referred to as a “Wait For Event” state, where processor 116 can verify each state of the state machine 200. Waiting state 204 can include switches on the front panel or UI 300 to trigger each state involved in the data acquisition and processing. The user can use this state to reinitialize the values of each subsequent state before triggering the subsequent state. FIG. 5B shows a block diagram of the waiting state 204, according to example embodiments. For instance, the green light that indicates that the background state acquisition is completed can be reinitialized at this state.

### Acquiring-Reference and Acquiring-Sample States

Acquiring-reference (or acquiring-background) state 206 can be used to trigger step 402 of method 400 and acquiring-sample state 208 can be used to trigger step 404 of method 400. FIGS. 5C and 5D show block diagrams of acquiring-background state 206 and acquiring-sample state 208, according to example embodiments. Both states 206 and 208 include the Sub-VI “acquisition.vi” or “acquire.vi”, which acquires and preprocesses signals. FIG. 5E shows a block diagram of the “acquisition.vi” Sub-VI, according to example embodiments. This Sub-VI follows a Producer/Consumer design pattern template provided by Lab VIEW™. This design is suitable for high-speed acquisition based on first-in-first-out (FIFO) data transfer. A “while” loop in LabVIEW™ can be used to run a code block several times until a specific condition is met.

The “Producer Loop” is a “while” loop with several Sub-VIs for signal acquisition and remains active until the laser stops lasing or emitting pulses. Processor 116 can store the generated data in a temporary memory space while transferred through the asynchronous queue to the consumer loop, as shown in FIG. 5E. The “Consumer Loop” is also a “while” loop structure that contains several Sub-VIs for data processing. It works in tandem with the Producer Loop, pulling the data from the queue in the same order generated by the Producer Loop.

Laser system 102 can generate an electrical trigger before each laser pulse emission. From the Producer Loop of the VI, analog-to-digital converter 110 can be initialized and waits for a rising edge of the electric trigger pulse from laser system 102 for an external trigger to reach one volt to initiate the acquisition of the signal from detector 106 connected to a channel 0 of the same analog-to-digital converter 110. Processor 116 may not store pre-trigger data during the acquisition. Therefore, the reference point parameter can be set to “0”.

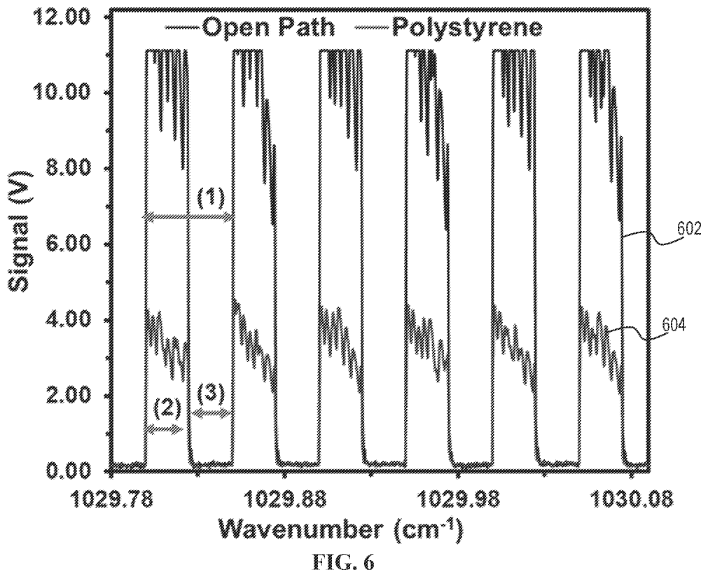

In some implementations, analog-to-digital converter 110 can sample digital values at a 200 MHz rate, and the recorded length can be set at 1000 ns to acquire the detector's response for the incident light and a portion of the dark signal. FIG. 6 shows plots illustrating a portion of the signal pulses' waveform from detector 106 for open path lasing (plot 602) and after placing the calibration polystyrene film (IR card; plot 604). The arrows indicate (1) 1000 ns record, (2) 500 ns detector response to incident light, and (3) dark signal. Each record can be appended as a waveform of each acquisition, as shown in FIG. 6. A decrease in the signal due to light absorption at approximately 1030 cm⁻¹ matches polystyrene's vibrational band. The queue transfers each record to the Consumer Loop, as shown in FIG. 6. Processor 116 can split each record, e.g., by invoking or executing a Sub-VI “extract portion.vi,” into two waveforms. The first 500 ns correspond to the detector's pulsed response after receiving a light beam from the laser. The following 500 ns correspond to the dark signal. A subtraction operation removes the dark signals from the pulse signals.

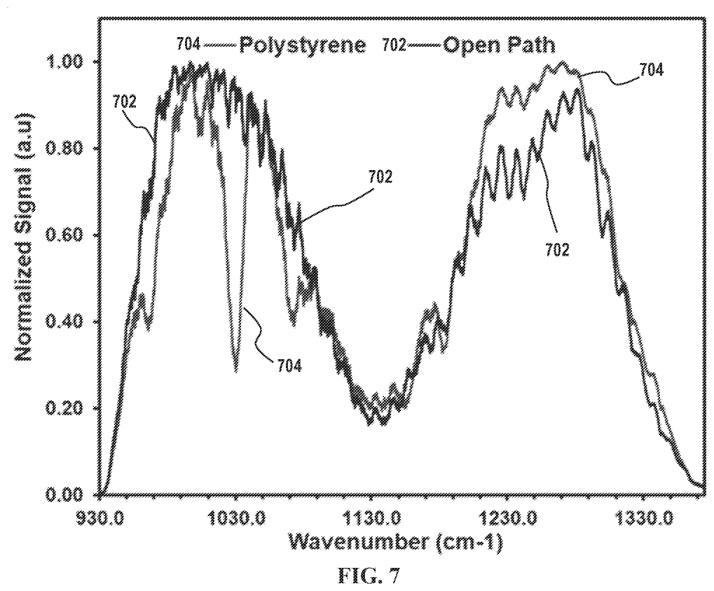

After the above-mentioned events, processor 116 can invoke Sub-VIs “integration function.vi” and “statistics.vi” to calculate the area under each pulse curve. Processor 116 can use each result to form a waveform of the laser beam for each sweep measurement. FIG. 7 shows a normalized signal of ten averaged waveforms before placing a polystyrene film (IR card) in front of the detector (no sample). Plot 702 shows the normalized signal before placing the polystyrene film and plot 704 shows the normalized signal after placing the polystyrene film.

Finally, processor 116 can save each file in TDMS format in a temporary local folder for background acquisition and signal of interest (sample). In some implementations, the user may wait a few seconds before acquiring replicates. A green light in the front panel or UI 300 can indicate when the user can acquire a new replicate by clicking the acquire background/sample button. The green light can turn off during the waiting state 204 when the system 112 is ready for the new acquisition.

### Processing State

Processor 116 can perform spectroscopic operations and signal filtering in processing state 210, as shown in FIG. 5F. In some implementations, the default calculation can be in transmittance mode. FIG. 5G shows a block diagram of a sub-VI “processing.vi” within the Processing State block diagram in FIG. 5F. In some implementations, the “Internal Folder Path” button must be activated in the front panel before processing to select if the user is interested in processing data acquired from previous states or noting the folder's location containing NI TDMS files already created, as discussed above in relation to FIG. 5E.

The “processing.vi” in FIG. 5G shows that processor 116 can average TDMS files within each folder, one folder for the background coadds and the other for the spectrum coadds, before spectroscopic calculation, e.g., transmittance. To accomplish this, processor 116 can invoke or execute a “List Folder.vi” to list all the files to be processed. Each “TDMS” file can have an “index.tdms” file containing information about the attributes of the data, such as channel, root, and group, to be avoided since it does not contain the signals' values be averaged. Instead, processor 116 can use a “match pattern.vi” to accomplish that purpose. After averaging the waveforms, processor 116 can calculate the pulse-to-pulse average. Since not all pulses have the same intensities due to temporal variations, it is desired to have an averaged value of the pulses' intensities that represent their instantaneous values. Then, processor 116 can invoke a “TDMS Read.vi” to read each file listed, and after that, processor 116 can extract signal values that correspond to the Y component. Finally, processor 116 can add the pulses per step using an “Add Array Elements.vi”. The pulses per step can be set to “one” for this study because the measurements were collected in sweep mode on the detector interface.

Multiple spectroscopic measurements are available, including transmittance, absorbance, relative reflectance, and Kubelka-Munk transformation. Each option is available as a list of strings available for selection at the button connected to the case structure. Each case within the structure contains the mathematical operation corresponding to the desired calculation.

Processor 116 can assign the wavenumber values considering linear increments of the step size (cm⁻¹), for example, with the initial wavenumber equal to 930 cm⁻¹ and the final wavenumber equal to 1375 cm⁻¹. Thus, when the diffraction grating of the laser system 102 moves, the radiation dispersion occurs as a function of time. A button or tab can connect to a Boolean “Filter” on the front panel 300 that activates the signal filtering in the block diagram of a case structure. Several filters can be used to remove noise from the data, including Savitzky-Golay, Fast Fourier Transform (FFT), and wavelet denoising filters. A Sub-VI represents each of the filters. The parameters of each Sub-VI used for spectral filtering are shown on the front panel in the processing tab, and the user must adjust them manually until the desired effect is obtained. Finally, if the user clicks on the “Save Spectra” button on the front panel tab processing, processor 116 can save the spectra as an ASCII text file in an internal folder.

Processor 116 can execute the processing state 210 to perform steps 406 and 408 of method 400, with a wavelet denoising filter selected. As discussed in further detail below, wavelet-based denoising filters outperform other types of filters in terms of mitigating or eliminating ringing effects, e.g., due to water vapor.

### Exit/Abort State

The exit/abort state 212 can be triggered or executed when the “Close Software” button is clicked or actuated. When triggered, processor 116 can clean the previously stored parameters and temporary files before exiting the exiting execution of the method 400 or the state machine 200.

Processor 116 can generate the filtered signal to be displayed on the display device 122. For instance, processor 116 can generate the display of the filtered signal within the UI 300, as depicted in FIG. 3. The display device 122 can include a screen of a computing device, such as a desktop, laptop, smartphone, tablet device, smart TV, or other display devices.

### Experimental Results

### Validation of the System

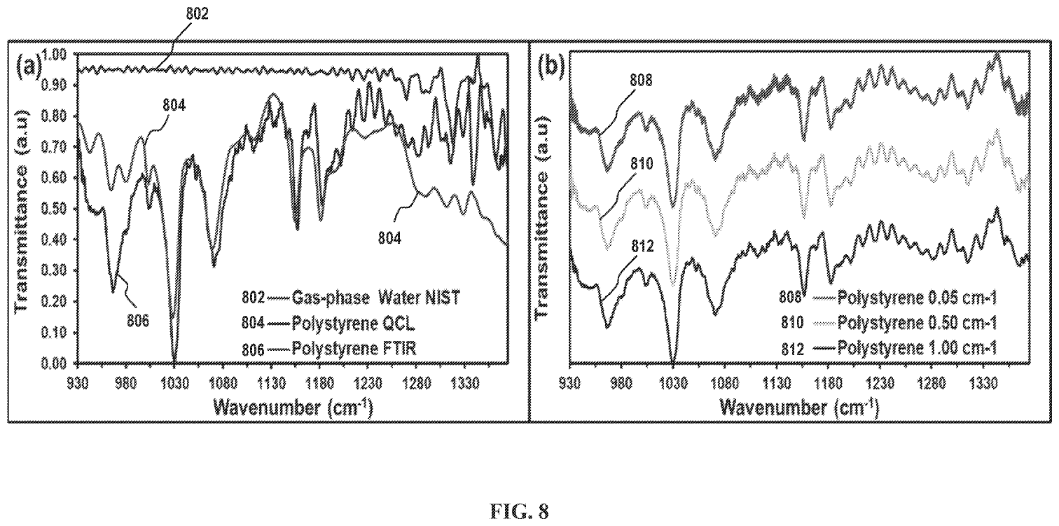

Ten acquisitions were collected and averaged in an open path experiment. The same procedure was followed with a calibration polystyrene film placed between the laser system 102 and the detector 106. The step size was set to 0.05 cm⁻¹ from the initial wavenumber of 930 cm⁻¹ and the final wavenumber of 1375 cm⁻¹ to obtain 9800 points. FIG. 8 shows (a) transmittance spectrum of polystyrene film from experiments, IR spectrum for water vapor from NIST, and FTIR spectrum of polystyrene film from Lancashire and Davies, and (b) Polystyrene spectra acquired with the experimental setup at 0.05 cm⁻¹ step size and data reduction to obtain spectra with a step size of 0.5 cm⁻¹ and 1.00 cm⁻¹. FIG. 8(a) shows a comparison between the data obtained from laser system 102 (e.g., QCL), after averaging ten acquisitions at a spectral resolution of 1 cm⁻¹, and data from the National Institute of Standards and Technology (NIST) database for polystyrene and water vapor, measured by a Fourier-transform infrared (FTIR) interferometer.

Artifacts are noticeable at approximately 1230 cm⁻¹. These artifacts are nonrelated to polystyrene but rather associated with interference fringes. In a recent report by members of this research group, these fringes were used to obtain information from the substrate and the chemicals deposited on them by applying fast Fourier Transform preprocessing of the RAIRS data used as statistical classification tools in multivariate analysis (MVA). Routines based on MATLAB can be programmed to “clean” the ripple structure of the reflectance data if no statistical inferences from the data are desired.

Measured spectral bands were compared with data from standard reference polystyrene films measured at the NIST to validate the accuracy of the MIR laser spectroscopic system. As shown in Table 2 below, a low absolute error percentage can be obtained. The validation of spectroscopic accuracy is fundamental for identifying chemical compounds, calibrating predispersive systems, and temporary assignment of vibrational bands of compounds.

TABLE 2
Comparison of vibrational bands for a polystyrene film using the
QCL system described herein and FTIR measurements from the NIST.

| | | |
|---|---|---|
| QCL | FTIR | Absolute |

| | |
|---|---|
| Wavenumber (cm⁻¹) | Error (%) |

| | | |
|---|---|---|
| 967.02 | 965.71 | 0.14 |
| 1029.29 | 1028.32 | 0.09 |
| 1071.14 | 1069.10 | 0.19 |
| 1156.74 | 1154.61 | 0.18 |

Data reduction was performed to identify the optimal spectral resolution for the calibration. The results for three spectra with different step sizes are shown in FIG. 8(b). The spectrum with a step size of 1 cm⁻¹ retains molecular signatures and significantly reduces the processing to 445 bands and, consequently, 445 ms per acquisition.

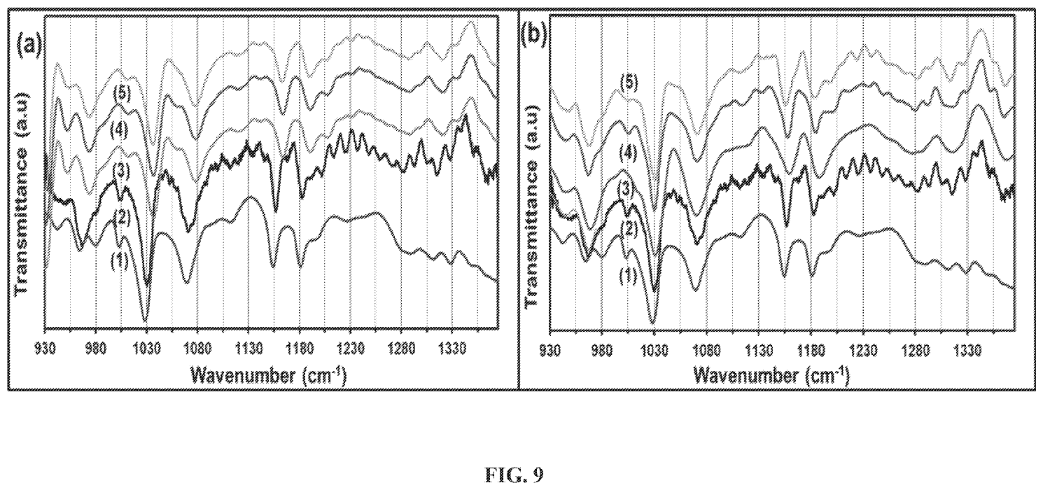

FIG. 9 shows plots illustrating comparisons between various types of filters. FIG. 9(a) shows a comparison of the application of filtered spectra of polystyrene film using low-pass Fourier Transform Filters with an order equal to three and a cut-off frequency at 0.028 after data reduction to 0.5 cm⁻¹ resolution using different topologies. MIR spectra of polystyrene are shown in FIG. 9(a) for (1) FTIR; (2) QCL without data processing; (3) FFT-Chebyshev; (4) FFT-Elliptic, and (5) FFT-Butterworth. A reduction in the noise and almost elimination of the fringes can be observed. However, there was a shift in the characteristic spectroscopic bands of polystyrene. Also, a “ringing” artifact was developed close to 930 cm⁻¹. Hence, an additional step to remove this part of the data must be applied when the Fast Fourier transform (FFT) filter is used for signal filtering.

A suitable alternative to de-noise the data without compromising the spectroscopic bands' precise localization is to use wavelet denoising. In contrast to FFT, wavelet transform provides spatial and temporal information about the signal and captures sudden signal changes. In our case, those changes correspond to vibrational bands of polystyrene in the collected MIR spectrum. This technique uses a multiresolution approach that decomposes the signal into high-frequency and low-frequency signals at each subsequent analysis level to remove high-frequency noise.

The levels of analysis are adjusted until the desired level of denoising is achieved. The wavelet coefficients (scale and position) are estimated to construct the signal using the wavelet from each level. There are various wavelet functions, including Daubechies, Symlet, and others. FFT uses only sine and cosine functions to reconstruct a signal with a lower resolution. Wavelet denoising is a powerful tool for complex signals, and its implementation in QCL measurements has been demonstrated. Discrete wavelet denoising (DWD) Sub-VI from the advanced signal processing toolkit Lab VIEW™ was used to denoise transmittance spectra of the polystyrene test film. The toolkit is not included in Lab VIEW™ academic licenses.

Several trials were conducted to demonstrate the spectroscopic system's capabilities to enhance the signal and find the optimal thresholding parameters to denoise the signal. The optimal levels of decomposition of the signal were approximately seven or eight levels. The signal is filtered using a “hard thresholding” mode for each level applied. The internal algorithm used to estimate the wavelet coefficients follows the hybrid thresholding rule, combining the universal method and Stein's Unbiased Risk Estimate (SURE) thresholding method. Finally, the rescaling method selected corresponds to the noise being “white” with unit variance. FIG. 9(b) compares multiple trials with different wavelets at different decomposition levels to evaluate the performance of this approach to remove noise from the data. Comparison of filtered spectra for polystyrene film using wavelet denoising transform. In FIG. 9(b), spectra for polystyrene are shown for (1) FTIR, (2) QCL without data processing, (3) wavelet denoising using Daubechies with 7 wavelets and 8 levels, (4) wavelet denoising using Symlet with 7 wavelets and 7 levels of analysis, and (5) wavelet denoising using Daubechies with 7 wavelets and 7 levels of analysis. Note that there is a significant reduction in noise using DWD without compromising the location of the polystyrene chemical signature in MIR.

### Applications

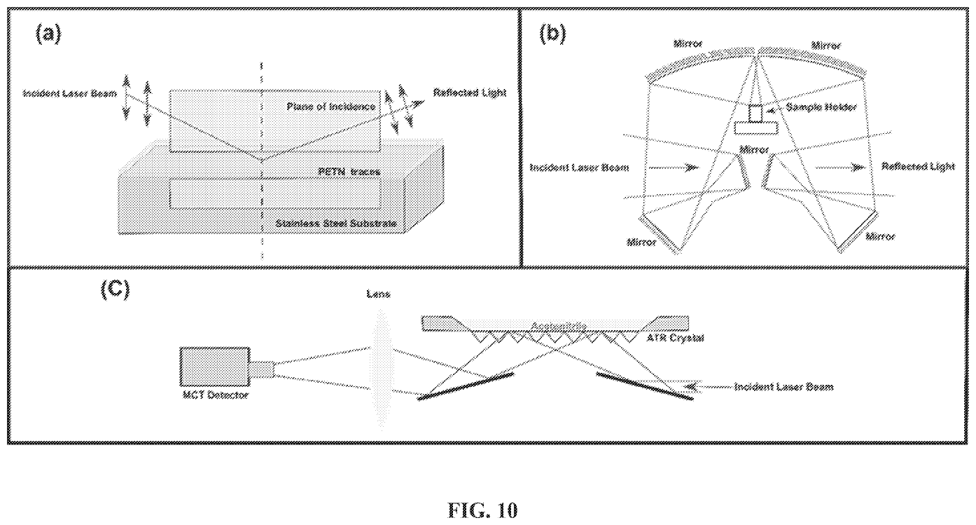

FIG. 10 shows schematic diagrams of experimental setups for (a) Diffuse Reflectance Infrared Spectroscopy (DRIRS), (b) Reflection-Absorption Infrared Spectroscopy (RAIRS), and (c) Attenuated Total Reflectance (ATR). Reflection-Absorption Infrared Spectroscopy (RAIRS) spectroscopic measurements were conducted near grazing incidence (84° with respect to the surface normal) of traces of a high explosive (pentaerythritol tetranitrate; PETN), deposited on a highly reflective surface as shown in FIG. 10(a). Aliquots of 50 μL of PETN in acetone solutions were deposited on a polished stainless-steel (SS) substrate (2.4×2.4 cm) to obtain surface concentrations from 24.5 to 52.5 μg/cm². The incidence angle was set to 84°, and the spectra were collected in 5 locations on the substrate. Three acquisitions were averaged at each location.

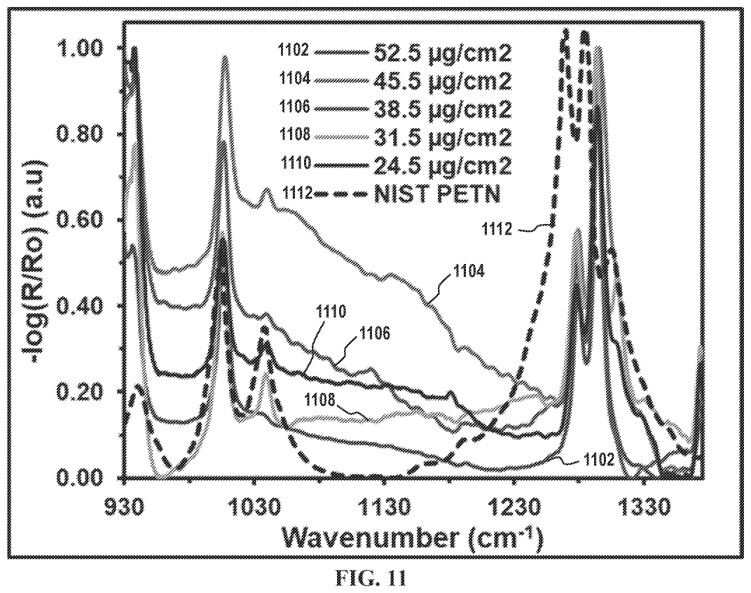

FIG. 11 shows the RAIRS spectra of PETN/SS at several concentrations. According to an example, the vibrational signatures of PETN in this spectral region match the PETN vibrational signatures reported in the literature and standard PETN spectra from NIST. The vibrational signatures include-CO stretching (1003 cm⁻¹), —NO2 rocking (1038 cm⁻¹), —ONO2 rocking (1272 cm⁻¹), —NO2 stretching (1285 cm⁻¹), and —NO2 rocking (1306 cm⁻¹).

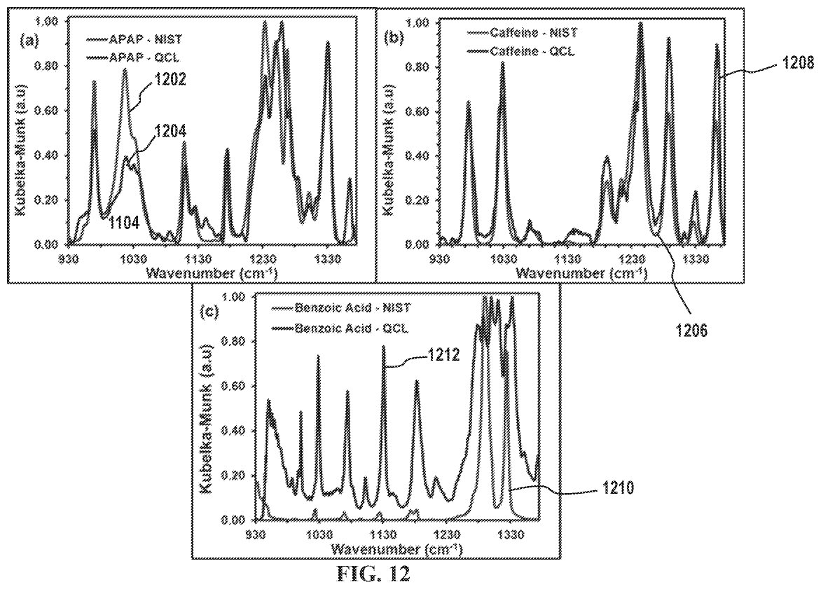

Diffuse reflectance spectroscopy (DRS) measurements of compounds in powder/crystals form at a fixed angle of incidence were also conducted. The optical setup is shown in FIG. 10(b). This setup is suitable for collecting the diffuse scattering light from solid samples. The sample holder was filled with a few grams of powder, and the excess powder was removed to form a flat surface. The caffeine, acetaminophen, and benzoic acid QCL spectra are shown in FIG. 12. The Kubelka-Munk (KM) transformation was applied to the reflectance data (spectra). KBr powder was used as a reference for the background signal. A comparison with the NIST standard reference spectra resulted in an excellent match. The data were filtered using the wavelet denoising technique, using Daubechies number 8 and eight threshold denoise levels. The QCL laser was configured to tune at a step size of 0.5 cm⁻¹ for both applications.

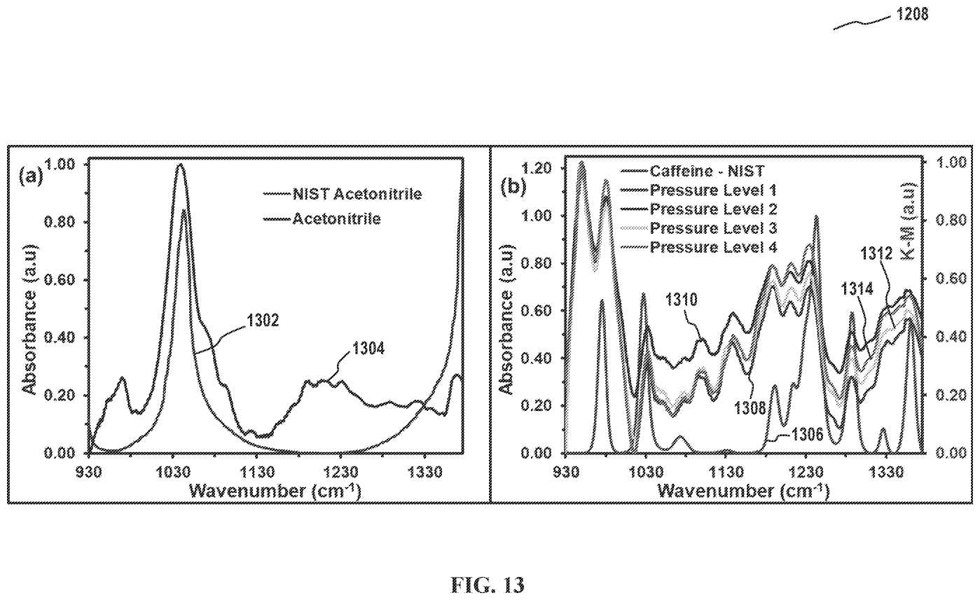

ATR-QCL measurements using the experimental setup shown in FIG. 10(c) were carried out on two samples. First, acetonitrile was analyzed by placing a small amount of the liquid on the ATR crystal (ZnSe). Spectra were acquired and averaged before the denoising using a Savitzky-Golay filter quadratic function and 25 points. FIG. 13 shows QCL-ATR spectra at different applied pressure levels of (a) acetonitrile and (b) caffeine crystals. A characteristic peak at 1042 cm⁻¹ associated with —CH3 rocking for acetonitrile was also verified in the spectra collected using the ATR-QCL and shown in FIG. 13 (a). As shown in FIG. 13 (b), the second sample was caffeine crystals. Each spectrum corresponds to only one acquisition. An order 2 with 25 points Savitzky-Golay filter was applied in FIG. 13 (b). A small amount of caffeine powder was placed on the ZnSe. The results were compared with experimental data collected by NIST. Due to two main factors, there are differences between measured and reference (NIST) spectra. First, in ATR, the evanescent wave penetration depth depends on the incident light wavelength, the crystal's refractive index (ZnSe), and the sample. The intensity height of the peaks from high wavenumber is more diminished than KM due to this factor. Second, there are redshifts at low frequencies due to changes in the sample's refractive index close to the absorption band. This phenomenon is known as anomalous dispersion.

Each method described in this disclosure, such as method 400, can be carried out by computer code instructions stored on a computer-readable medium. When executed by one or more processors of a computing device, the computer code instructions can cause the computing device to perform that method.

While the disclosure has been particularly shown and described with reference to specific embodiments, it should be understood by those skilled in the art that various changes in form and detail may be made therein without departing from the spirit and scope of the subject matter described in this disclosure.

While this disclosure contains many specific embodiment details, these should not be construed as limitations on the scope of any subject matter or of what may be claimed, but rather as descriptions of features specific to particular embodiments of particular subject matters. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order or that all illustrated operations be performed to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated into a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

What is claimed is:

1. A system comprising:
one or more processors; and
a memory storing executable instructions, which when executed, causes the one or more processors to:
receive reference data points representing samples of a first signal generated by a detector responsive to a first light signal emitted by a laser system, the first light signal interacting with a reference medium before reaching the detector;
receive sample data points representing samples of a second signal generated by the detector responsive to a second light signal emitted by the laser system, the second light signal interacting with a sample medium before reaching the detector;
generate a ratio signal using the reference data points and the sample data points;
apply wavelet-based filtering to the ratio signal; and
cause the filtered ratio signal to be displayed on a display device.

2. The system of claim 1, wherein the laser system includes a quantum cascade laser (QCL).

3. The system of claim 1, wherein the detector includes a mercury-cadmium-telluride detector.

4. The system of claim 1, wherein the one or more processors are configured to provide a user interface (UI) and receive a signal via a user interface (UI) to trigger at least one of reception of the reference data points, reception of the sample data points, or processing of the reference data points and the sample data points.

5. The system of claim 4, wherein the UI includes a tabs or icon corresponding to different states of a state machine for executing reception and processing of signals emitted by the laser system.

6. The system of claim 5, wherein the state machine includes an initialization state for setting parameters for controlling the reception and processing of signals emitted by the laser system.

7. The system of claim 5, wherein the state machine includes a wait state during which the one or more processors is configured to wait for input instructions via the UI.

8. The system of claim 5, wherein the state machine includes a state for reception of reference data points.

9. The system of claim 5, wherein the state machine includes a state for reception of sample data points.

10. The system of claim 5, wherein the state machine includes a state for processing of the reference data points and the sample data points.

11. A method comprising:
receiving, by a computer system including one or more processors, reference data points representing samples of a first signal generated by a detector responsive to a first light signal emitted by a laser system, the first light signal interacting with a reference medium before reaching the detector;
receiving, by the computer system, sample data points representing samples of a second signal generated by the detector responsive to a second light signal emitted by the laser system, the second light signal interacting with a sample medium before reaching the detector;
generating, by the computer system, a ratio signal using the reference data points and the sample data points;
applying, by the computer system, wavelet-based filtering to the ratio signal; and
causing, by the computer system, the filtered ratio signal to be displayed on a display device.

12. The method of claim 11, wherein the laser system includes a quantum cascade laser (QCL).

13. The method of claim 11, wherein detector includes a mercury-cadmium-telluride detector.

14. The method of claim 11, comprising:
providing a user interface (UI); and
receiving a signal via a user interface (UI) to trigger at least one of reception of the reference data points, reception of the sample data points, generation of the ratio signal or processing of the reference data points and the sample data points.

15. The method of claim 14, wherein the UI includes tabs or icons corresponding to different states of a state machine for executing the method.

16. The method of claim 15, wherein the state machine includes an initialization state for setting parameters for controlling the reception and processing of signals emitted by the laser system.

17. The method of claim 15, wherein the state machine includes a wait state during which the one or more processors is configured to wait for input instructions via the UI.

18. The method of claim 15, wherein the state machine includes a first state for reception of reference data points and a second a state for reception of sample data points.

19. The method of claim 15, wherein the state machine includes a state for processing of the reference data points and the sample data points.

20. A non-transitory computer-readable medium storing computer instructions, the computer instructions when executed by one or more processors cause the one or more processors to:
receive reference data points representing samples of a first signal generated by a detector responsive to a first light signal emitted by a laser system, the first light signal interacting with a reference medium before reaching the detector;
receive sample data points representing samples of a second signal generated by the detector responsive to a second light signal emitted by the laser system, the second light signal interacting with a sample medium before reaching the detector;
generate a ratio signal using the reference data points and the sample data points;
apply wavelet-based filtering to the ratio signal; and
cause the filtered ratio signal to be displayed on a display device.
